(19) United States
(12) Patent Application Publication
(10) Pub. No.: US 2009/0082045 A1
(43) Pub. Date: Mar. 26, 2009

(54) BLAST VIDEO MESSAGES SYSTEMS AND METHODS

(75) Inventors: Dion Joseph Mitchell, San Diego, CA (US); Steven Christopher Taylor, San Diego, CA (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: BlastMsgs Inc., San Diego, CA (US)

(21) Appl. No.: 12/239,627

(22) Filed: Sep. 26, 2008

Related U.S. Application Data
(60) Provisional application No. 60/995,358, filed on Sep. 26, 2007.

(51) Int. Cl. H04W 4/00

(52) U.S. Cl. 455/466

(57) ABSTRACT

Systems and methods for creating and using short video messages are described. A short message and a video clip can include a verbalization of the short message by a character. The verbalization may be emphasized by an attribute of the character including a demeanour of the character, an intonation of the verbalization, a volume of the verbalization, a gesture or a facial expression. Methods for expressing a message are described. A video is selected from a catalogue of short video, wherein the selected video conveys a message and transmitting the message to an mobile electronic device adapted to play the video clip. The video may include characters, caricatures, cartoons, a movie clip, a television program clip, an advertisement and/or an alert.

### CROSS-REFERENCE TO RELATED APPLICATIONS

The present Application claims priority from U.S. Provisional Patent No. 60/995,358, filed Sep. 26, 2007, which is expressly incorporated by reference herein in its entirety and for all purposes.

### BACKGROUND OF THE INVENTION

1. Field of the Invention

The present invention relates generally to messaging and more particularly to multimedia messaging.

2. Description of Related Art

The popularity of individualized devices for receiving server-based data communications associated with cellular phones and other portable devices has become prevalent. As cellular phones become increasingly sophisticated, the devices have been adopted for use in text messaging and text messaging accompanied by video and other multimedia systems.

However, messaging systems such as SMS and MMS are basic and often cumbersome to use. Users often abbreviate words and phrases in text messages and content is diminished as a result. Thus, as capabilities of the devices have increased, information content has generally decreased.

### BRIEF SUMMARY OF THE INVENTION

Certain embodiments of the present invention comprise systems and methods for providing enhanced short messaging. The systems and methods enable the use of short video clips that enhance and reinforce the meaning of text messages. In certain embodiments, the short video clips may supplant the text portion of the message.

Certain embodiments of the invention provide a short expressive message. Some of these embodiments comprise a short message and a video clip including a verbalization of the short message by a character. In some of these embodiments, the verbalization is emphasized by an attribute of the character. In some of these embodiments, the attribute includes a demeanour of the character. In some of these embodiments, the attribute includes an intonation of the verbalization. In some of these embodiments, the attribute includes a volume of the verbalization. In some of these embodiments, the attribute includes a gesture. In some of these embodiments, the attribute includes a facial expression. In some of these embodiments, the video clip comprises a head shot of the character. A head shot is known in the television and movie arts as a video or still image of the head and shoulders of a subject. In some of these embodiments, the head shot is captured from a non-perpendicular angle relative to the character. In some of these embodiments, the head shot is captured from a position locate above the head of the character.

Certain embodiments of the invention provide methods for expressing a message. Some of these embodiments comprise selecting a video from a catalogue of short video, wherein the selected video conveys a message and transmitting the message to an mobile electronic device adapted to play the video clip. In some of these embodiments, the selected video conveys the message verbally. In some of these embodiments, the selected video conveys the message through a text message. In some of these embodiments, the selected video includes one or more characters. In some of these embodiments, the characters include a caricature. In some of these embodiments, the characters include a cartoon character. In some of these embodiments, the selected video includes a movie clip. In some of these embodiments, the selected video includes a television program clip. In some of these embodiments, the selected video includes an advertisement. In some of these embodiments, the selected video includes an alert. In some of these embodiments, the video is selected responsive to a request from a user of a wireless device. In some of these embodiments, the video emphasizes the message through the behavior of a character portrayed in the video.

### BRIEF DESCRIPTION OF THE DRAWINGS

FIG. 1 is a schematic depicting a simplified example of a system according to certain embodiments of the invention.

FIG. 2 is a flowchart of an example of a registration process according to certain aspects of the invention.

FIG. 3a is a picture showing a subject captured at representative angle according to certain aspects of the invention

FIG. 3b shows various camera angles used to capture video according to certain aspects of the invention.

FIG. 4 shows two screenshot examples of Blast Messages according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

As used in this description, the term “mobile device” refers to, and encompasses, electronic devices that are portable and that can communicate with a network capable of providing data communications over which multimedia content may be transmitted. Mobile devices can include devices that communicate wirelessly such as cellular telephones, personal digital assistants (“PDAs”), laptop computers, smart telephones, smart displays, micro personal computers, Email clients, multimedia players and devices that combine functions such as multimedia players and cell phones. Mobile devices are typically equipped with a display, an input mechanism such as a keyboard, microphone or touch panel, a processor and storage and mobile devices are typically capable of downloading, configuring and/or executing applications that enhance the mobile device capabilities in accordance with aspects of the present invention.

In certain embodiments of the invention, multimedia clips can be transmitted, at the request of a user of a mobile device, to a recipient who is typically also a user of a mobile device. The form and content of the multimedia clips are structured and configured to convey a specific recognizable meaning. For example, a multimedia clip may be created to convey a message that notifies a recipient that the user of the mobile device is late. To that end, the multimedia clip may show a character gesturing and vocalizing an “I'm late” message. The recipient may rapidly assimilate the explicit and implicit meanings of the message by observing the motions and demeanour of the character, by listening to the vocalized message, by reading accompanying text and by various combinations of observing, listening and reading.

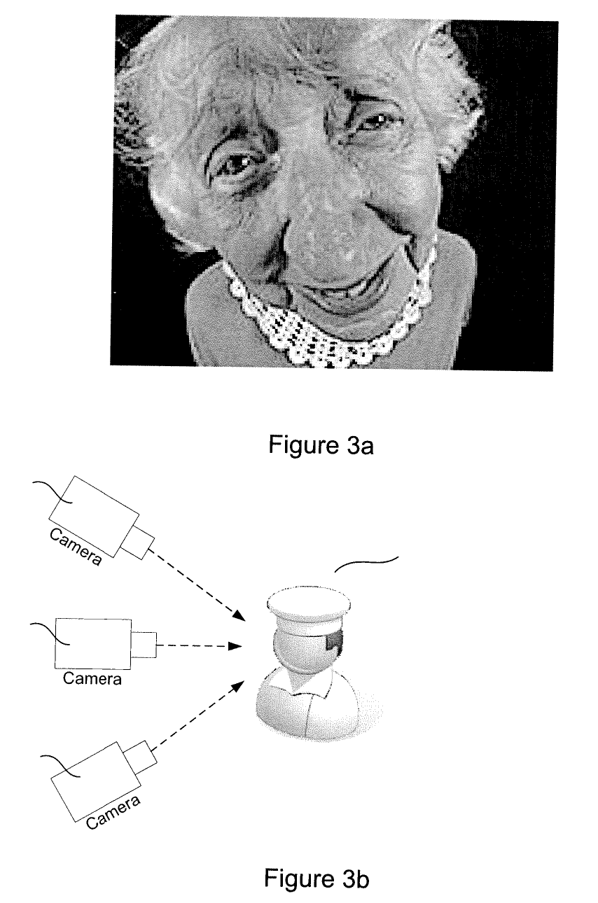

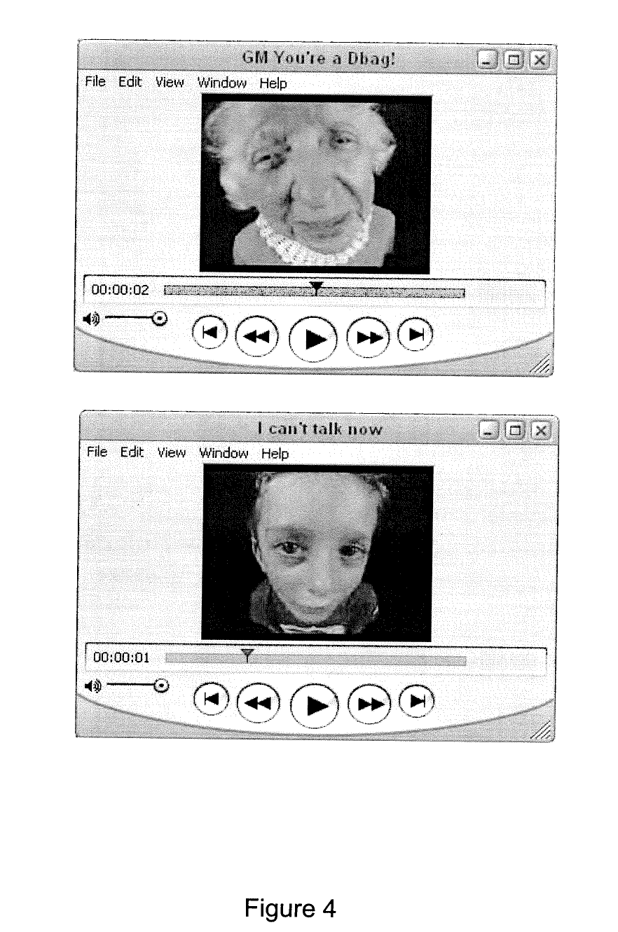

In certain embodiments, the gestures and posture of the character (see FIGS. 3a, 3b and 4) can convey the content of the message or can provide a subtextual message. An example of subtext conveying messages may be a departing message in which the character vocalizes an intent to leave while making a gesture that indicates that the character (and, perhaps the sender by extension) is frustrated, overwhelmed, completely finished. In the latter example, the use of a vernacular expression may reinforce the gesture: e.g. the statement “I'm outta here” may be combined with a salute, a wave or other gesture. FIG. 4 depicts screenshots related to two Blast Messages.

Messages comprising brief statements and/or vocalizations of emotion, intent, question, offer, answer, etc. may be prefabricated and available to a sender at short notice, thereby enabling rapid multimedia communication regarding common events and occurrences and social interactions. Messages that include a multimedia expression in the manner and that can be quickly accessed and/or combined/composed such, as those described, are among the message types that will be referred to herein as “Blast Messages.” The term “Blast Clips” will be used in this description to include Blast Messages and derivative and expanded forms of Blast Messages, which serve specialized purposes that include advertising, alert, social networking, viral distribution, premium content, license-controlled content and other forms of Blast messages.

Systems constructed according to certain aspects of the invention typically maintain a catalogue of Blast Messages on one or more servers and, portions of the catalogue can be copied and stored in user mobile devices where they can be maintained as a library of Blast Messages or links and indices that cause a system to include the Blast Message in a communication transmitted by a user of the mobile device. For example, a first user may wish to send a greeting that has certain characteristics, such as a greeting that has an “impatient” undertone. The user may select a Blast Message from a list displayed on their mobile device. The Blast Message, if stored locally, can then be transmitted along with any customized text or other multimedia content. If the Blast Message is not preloaded on the mobile device, then the Blast Message can be added to custom text or other media at a server or way station in the communication path. In some embodiments, the mobile device can request a copy of the selected Blast Message and can augment the Blast Message locally, before transmitting to the recipient.

In certain embodiments, a user may generate a personal Blast Message for contemporaneous or future use. The Blast Message can comprise a video file created by the user. The user may create the video file using a video camera to record the user's voice and image. The video camera may also be a mobile phone digital camera, or any suitable digital camera known in the art. The camera may also be a non-digital video camera, where the resultant video can be outputted to a digital source to convert the video into an acceptable digital format. The user may also record the voice and image of one or more individuals in a similar manner, or by use of an electronic animated character, with a customized message. For example, the phrase “call me back” can be a recording of an individual or cartoon character saying “call me back”, with a corresponding file name identifying the unique message.

In one example, a video file is created for inclusion in a Blast Message and an audiovisual recording is made of an individual or an electronic animated or cartoon character verbalizing phrases that would normally be sent in an SMS/MMS text message or Instant Message. The video file may be edited to include a separate audio file and can be further edited for length and content using any suitable editing process, software or system. This resultant “proto-Blast Message” is optionally compressed into an acceptable electronic file format that is compatible with a mobile device, telephone, PDA, or other mobile device. For example, the compression type can be 3GPP and other types that are compatible on cell phones or other mobile devices, such that the electronic video message file can be downloaded to a mobile phone or other mobile device, as appropriate.

The user can elect to make the finished Blast Message available by providing the electronic message file through an Internet website. The Blast Message may be disseminated using a WAP-push. The term “WAP-push” is used herein to refer to a wireless application protocol that can facilitate access to the Internet from a mobile device, telephone or PDA. As known in the art, a WAP-push can refer to a specially encoded message which includes a link to a WAP address, and allows WAP content to be directed to the mobile handset or PDA with a minimum of user intervention.

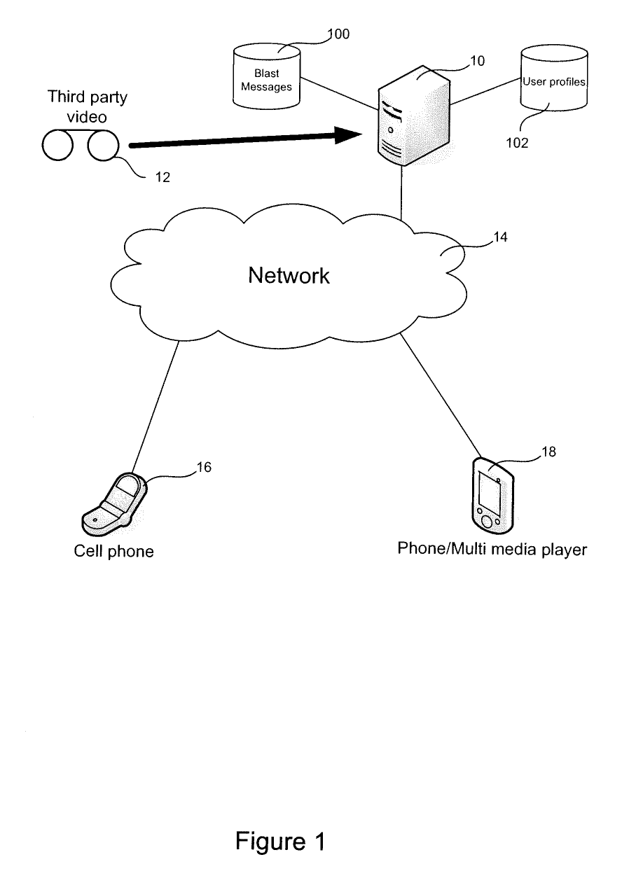

With reference to FIG. 1, certain embodiments of the invention comprise one or more servers 10 and databases 100 and 102. In the example, database 100 may be a video repository that maintains a catalogue of Blast Messages and other Blast clips. Database 102 illustrates one method of maintaining user profiles and biographical data. Other databases may be deployed to manage advertising content, schedule transmissions, manage accounts and so on. Databases 100, 102 and other databases may be dispersed over a plurality of servers and physical locations. Server 10 can be accessed using a network 14 that may comprise the Internet, private networks, wireless telecommunications networks, etc. Blast Messages can be sent between mobile devices 16 and 18, including between combinations of cell phones 16, email clients (not shown), PDAs (not shown), multimedia players 18 and other types of devices. This means of communicating back and forth between the users can be combined and/or interspersed with text and more general multimedia messages. Sending and receiving the messages can be accomplished utilizing existing mobile networks. The length of the messages may be varied and longer video files can be electronically compressed in order to minimize transmission delays and to avoid other potentially negative issues associated with the transfer of larger electronic files over wireless networks. Compressed video files can be accessed on a multitude of conventional mobile and wireless devices such that video playback is achieved without requiring extended storage capabilities on these devices.

In certain embodiments, Blast Messages and other Blast Clips can be disseminated through a social networking forum such as FaceBook, MySpace, YouTube, and other sites, including sites that provide instant messaging service. Blast Clips can be developed that are suited to social networking and can be expanded to provide different formats, lengths and so on. In one example, Blast Messages may be integrated into FaceBook as a “poke,” used to prompt or otherwise get the attention of a contact in the social network.

In certain embodiments, a form of Blast Messages can be created specifically to advertise films, music, and TV shows. For example the Fox network could launch a reminder blast ad with Kiefer Sutherland saying “Watch 24 tomorrow at 9:00 PM.” These clips, referred to herein as “Blast Ads” can be sent to a mobile phone or any other mobile and/or wireless device. Blast Ads may be created using similar techniques used for Blast Messages.

In certain embodiments, one type of Blast Message comprises small, viral mobile phone video clip trailers, which will be variously referred to herein as Blast Message Alerts. In one embodiment, a Blast Message Alert may include a clip of movie and/or television programming as an alert designed to remind movie-goers of upcoming releases and TV audiences of changes to scheduling of certain shows and of addition of special episodes. Targets of the Blast Message Alert may identify preferences in advance, including favourite show, preferred movie genre, favourite actors, authors, directors and so on. Movie, TV programs and other subjects of interest may be assigned a code that identifies the subject using a number of different indicia including one or more of a genre, a series identifier, an episode identifier, cast, director, time of performance, location, date of release, availability on media such as DVD, and so on. In one example, an identifier may include the code AG2007 representing American Gangster, released in the year 2007.

In certain embodiments the Blast Message Alert may include a video providing a trailer, advertisement or other information. In the example provided, the trailer may include highlights of a movie “American Gangster” that was released in 2007 and which can be viewed by the target of the Blast Message Alert. The trailer may be accompanied by information detailing the performance options including nearest location of a theatre, availability of recorded media such as DVD, HD-DVD, BluRay, Pay-Per-View or on commercial television outlets including cable providers. Typically, viewers are instructed on how to receive Blast Message Alerts, after the movie/episode/preview has ended and/or during the preview in a special area; in one example, the special area is located at the bottom of the screen.

In certain embodiments, the target user may request that a reminder be sent immediately prior to the performance of the movie. The user may request a reminder two days before, on the day of or at some other predetermined or selected time before the actual release of the movie. Any available method for communicating a request may be used. In one example, a user may send a message such as a text message reciting the code AG2007 to an identified number, optionally specifying a reminder option. At the appointed time, a multimedia message (e.g. a MMS message) clip reminder of the release date for the “The American Gangster.”

In certain embodiments, a promotion and/or reminder may include information regarding date and places of release of movies and broadcast information for television programming. In certain embodiments, the promotion and/or reminder is provided in an entertaining manner, typically in the form of clips that can be sent directly to a user mobile phone. Certain clips may be provided in a file size that is conducive to viral forwarding within an SMS or other system. In the movie example, when the “text in” (sign up person) receives the Blast Message Alert trailer on the designated release day, the clip file size is small enough to forward to anyone via text or SMS, typically with an ability to add a message such as “movie tonight” or “do you want to see this?”

In certain embodiments, the content of a Blast Message Alert can be managed and traced in compliance with digital rights management (“DRM”) requirements. Information that may be recorded by systems include user info such as details regarding a Mobile Phone and registration information. Typically, access to a database of users who signed up for notification can be provided and such information may be used to generate revenues from text message.

Novel methods of advertising are provided and contemplated. Such methods can have very low implementation costs and offer an ability to share revenues between service providers and content providers. In certain embodiments a bar-code can be added to a Blast Message, Blast Message Ads and Blast Message Alerts. Typically, barcodes can be provided at the end of each blast ad clip as a “Tag.” The barcode may be two, three or multi-dimensional and may include coupons or identifiers that can be used at retail outlets, redeem for prizes, discounts, or access to events.

In certain embodiments, Blast Messages and other Blast Clips are created using a combination of video captured using a camera, audio tracks and, in some cases, animation. A video camera or other device can be used to capture and record live video and audio. Existing video may be incorporated and/or modified for use in the Blast Clips. In certain embodiments, Blast Messages are characterized by images of subjects captured from indirect angles. In the example of FIG. 3, a video of a subject may be captured from a position vertically above the subject and/or at an indirect angle relative to the subject (e.g. 45 degrees offset to the right or left of the subject). The message in Blast Message can be performed by an individual, a group of persons, animated characters and/or scenes from a movie or animation. Certain embodiments provide tools that enable user to capture and create Blast messages using video cameras, computers and other technology suitably programmed and configured. Commercial software products can be used for creation and playback of Blast messages including QuickTime, Windows Media Player, Sorenson, Nero, etc.

In certain embodiments, Blast Messages include multimedia content reflective of message to be conveyed. In that regard, a subject may vocalize phrases that convey a message. Examples of phrases are legion and include “That's Jacked Up” and “I am running late.” The Blast Message may also include clips from previously recorded movies, cartoons, games, etc. For example, a Blast Message may convey a sentiment adequately expressed by including the iconic scene from “Dirty Harry” in which Clint Eastwood says, “You feel lucky, punk?”

Blast Clips can be maintained in a repository stored on one or more network servers. Access to the repository may be provided through a database management system that employs SQL, Oracle, MySQL, or other query language. In certain embodiments, queries may be created based on messages, response and context provided by a user through a mobile device. However, it is contemplated that an agent on the mobile device or on an intermediary in the network may compose structured queries on behalf of the user.

In certain embodiments, the repository may be accessed using a web interface provided by a website, a WAP site, a kiosk using a URL address and at third party multimedia and/or social networking sites. Users may be required to register with the system by providing a profile identifying personalized information, including for example, age, location, ethnicity, etc. Based on the profile and specific search requests, a server can search the repository for a selection of appropriate Blast Messages for display to the user. In some embodiments, the search can include other repositories provided by third parties such as a social networking system. The site typically provides delivery options for Blast Messages including sending the Blast Message directly to the user's mobile phone or other electronic device for storage and playback. User can also view the video by streaming from a WAP site (for example) without downloading and storing the Blast message.

In certain embodiments, the can optionally receive applications configured for the user's mobile device. These applications can include an agent for constructing queries, a decryption application for decrypting premium, secure and/or other protected content, a media player, a messaging agent and other such tools. The applications can be provided in a form executable by the mobile device and may be stored internal to the device. The applications may be provided or stored on storage media as instructions and data executable by the mobile device. The applications may be provided in Java, or for execution in another runtime environment. Applications may be provided in code native to the operating system provided on the mobile device.

In certain embodiments, users can select Blast Messages by sending a message to a server. The message may be a text message (SMS), multimedia message (MMS), an Email or other form of message. The message may delivered via short code, Internet address, touch tone, etc. The message is typically parsed and/or analyzed. A repository of Blast Messages can then be searched and results may be transmitted to the user. The server can also randomly send message videos or images based on the category previously identified and selected by the user when the user is registered in the system. A user can send a key word via SMS or MMS to the server to request a message video

In certain embodiments, and as mentioned above, Blast Messages can be preloaded on a mobile device. One method of obtaining Blast Messages is performed by a user of the mobile device searching a web-based catalogue of Blast Messages using a computing device connected to the Internet. The user can select one or more Blast Messages and request download of the messages to the mobile device. Typically, the user identifies a telephone number of the device. Alternatively, the user may request transfer of desired Blast Messages to an account maintained by the user that can later be connected with the mobile device for download of the transferred Blast Messages.

In certain embodiments, a user of a mobile device may review a catalogue using text messages. In response to a query, the catalogue systems can respond with a list of messages that match the query and the user can select from among the listed Blast Messages by responding with a code or number provided in the list. Thus for example, the response to a query may yield 4 matches numbered 1-4 and the user may simply text the number of the desired Blast message. It is contemplated that the download mechanism may provide preview versions of the Blast Message. Previews may be disabled versions of the Blast Message and may be encoded with license management components that enable a mobile device to display the Blast message a certain of times and/or over a certain period of time. Typically, agent software is provided to the mobile device that enables download, decryption and limited use of the previewed Blast Messages.

In certain embodiments, a user of a mobile device can capture a received Blast Messages, Blast Message Ads and/or Blast Message Alerts, which will be collectively referred to as “Blast Clips.” Captured Blast Clips can be stored for future use and may be transmitted to other mobile devices. Consequently, Blast Clips can be propagated virally, from user to user. In this regard, certain Blast Clips having licensed or protected content may be designated as premium Blast Clips for which limited distribution is permitted. For example, viral distribution of premium Blast Clips can be enabled using agents executed on the mobile device that can decrypt and play premium Blast Clips a preset number of times or for a limited time period on each new device. Premium Blast Clips may include mechanisms that prompt a mobile device user to download agent software if the agent is not present on the mobile device. Thus, embodiments of the invention provide marketing and sales opportunities for premium content. In certain embodiments, the premium Blast Clips may provide an option, through a hyperlink, text message, telephone number, etc., to purchase a Blast Clip or, in the instance of a Blast Message Ad, the content advertised in the Blast Message Ad. Typically, agent software can track and report sources of premium Blast Clips and this information, together with reports from websites distributing purchased items, can be used to provide reimbursement to distributors of Blast Clips.

Certain embodiments of the invention employ transactional processes using mobile devices. As discussed, queries, requests, selections of content and purchases can be made from the mobile devices. In one example, transaction can use web browsers, text messaging and other proprietary software to facilitate interactions. Electronic query may comprise a single communication such as a text message to the server as described, and may also comprise a series of items selected from a list from a preformatted electronic list that can be simultaneously sent by the user. Users can also dial a specified phone number from the mobile device and/or electronically access a relevant website to select a desired item or items from a pre-populated list. Further, the server, phone number, website, etc., may include one or more groups of lists that facilitate ease of use for the user in selecting the desired items. The lists, for example, may be a set of checkboxes where the user simply selects one or more items of interest by placing a check in the specific box or boxes. The server may be a dedicated server, an associated server, a group of one or more interfaced servers, or the like. Further, multiple servers may be used to organize similar content therein, thus maximizing efficiency in providing users with multiple servers from which to choose specific desired content, while also providing redundant capability where a server interruption will not cause any interruption in service.

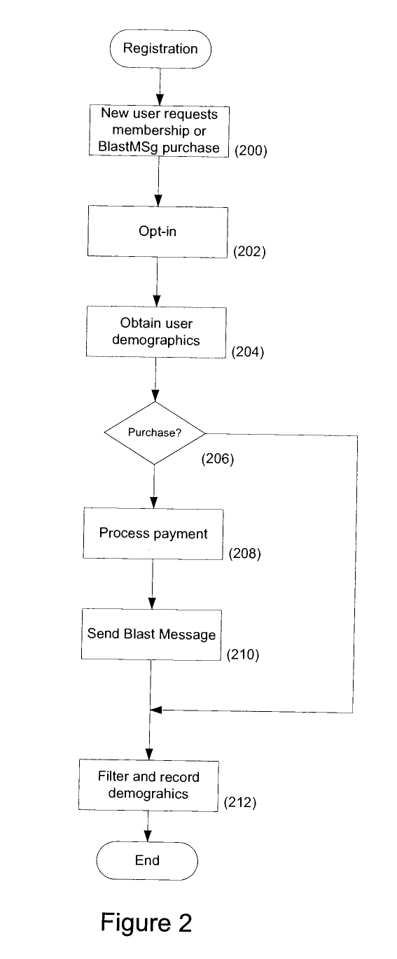

FIG. 2 illustrates a registration process according to certain aspects of the invention. Registration can be initiated when, at step 200, a user requests registration or attempts to obtain a Blast Message or related product. In certain embodiments, a server may respond to a query from a mobile device by sending an electronic opt-in message at step 202. This opt-in message may be in the form of a simple “yes” or “no” check box and can be provided as text message identifying certain information related to the mobile device and/or user serving as the user's acceptance to the opt-in message. Further, the opt-in message can include an electronic response generated via an electronic mail message using one or more specific websites or any other internet-based system. Upon sending the acceptance to the opt-in message or its equivalent, the server may be configured to provide the user with a screen for capturing the user profile at step 204. User profiles may include demographic information including name, city of residence, profession, age group and other information useful in customizing user experience. User profiles may be augmented by searching available public data, including data obtained on a social network and information associated with the mobile device. User profiles may be gathered and used for marketing purposes, particularly where users provide information identifying interests and preferences. User profiles may be used for targeted marketing campaigns.

Servers receiving registration and/or opt-in information may also present a payment form at step 208, if it is determined at step 206 that the new user wished to purchase a Blast Message. If, at step 206, it is determined that the new user selected a membership level requiring a membership fee, then the payment page/form is provided to the new user at step 208. Otherwise control passes to step 212. Membership may be for a Blast Message/multimedia distribution club and/or for purchases made of any other items identified in a Blast Clip. A user may submit payment at step 210. At step 212, the profile and demographic information may be processed and analyzed. User profiles may be filtered for certain key demographics that would identify a group of registered users by interest, age group, residence, income bracket and so on. It is contemplated that many user profiles will be provided through traditional computer systems although increased capabilities of mobile devices may render personal computer-based registration unnecessary. In order to provide videos for purchase or rent at a specified charge.

Having received an order for a Blast Clip, servers may initiate transmission of requested Blast Messages or other content to the user. Depending on the nature of the purchase, a server may selectively transmit an entire multimedia file in a burst transmission for storage and subsequent playback on the user device. Servers may also stream multimedia content to the mobile device and the receiving device can play the video immediately the start of stream arrives, or after buffering a portion of the stream. Servers may also provide an active hyperlink that electronically directs the user to the video for immediate streaming to the device.

In certain embodiments, Blast Clips can place symbols, trademarks, images and multimedia content that is generally associated with a product or business entity. Such product placement may be added on demand to Blast Clips transmitted to user mobile devices by insertion prior to distribution or by selection of Blast Clips that were created with product placements. In one example, a video overlay and/or banner can be added to a Blast Clip. In another example, an audio track can be added or replaced. In another example, a Blast Message may be created in which a character carries a product, wears a logo or clothing item associated with a commercial product or vocalizes a catch phrase used to advertise a commercial product.

In certain embodiments, elements can be added to Blast Messages and Blast alerts and Blast Ads that provide an active link to an advertiser and/or supplier website, an order page, a list of other available Blast Clips and so on. An advertising block or logo may also comprise entries for a plurality of advertising entities. These entities may be identified buy product sequential or concurrent product placement or by displaying, for example, an electronically rotating banner or block. In another example a first advertising logo is displayed at the beginning of the Blast Message and a second advertising can be displayed as an overlay or block during the Blast Message while a third advertising logo is displayed toward the end of the Blast Message. Other configurations and sequences are contemplated to fall within the scope of the invention.

Servers may typically provide multimedia content in one or more electronic file formats selected according to the capabilities reported for the mobile device. Examples electronic file formats include 3G, 3G2, 3GP, 3GGP, 3GPP, 3GPP2, AV1, MP4, and WMV formats. The use of other compressed and uncompressed electronic file formats is also contemplated for use in embodiments of the invention. The advertising block may comprise an active link to the advertiser's or supplier's website or other electronic destination, such as an order page, a list of other available electronic videos, and the like. The advertising block or logo may also consist of one or more different entities, such as by electronically rotating the content within the block. In one example, an advertiser's logo is displayed at the beginning of the video playback, another entity's logo plays during the video, and still another entity's logo is displayed toward the end of the video. The speed with which the entity logos appear or are cycled through the video may be adjusted.

The term “video” as used herein refers to motion, as distinguished from still (i.e., static), picture images. This term further includes animated motion pictures, while also including electronic film images of real-life images. The term also encompasses streaming videos, whereby the initiation of a video transmission results in immediate playback on the receiving mobile device without waiting for the complete video file to be transmitted and received on the mobile device. Also, burst videos are included in the term, where electronic data packets of information are transmitted intermittently to the mobile device, so that the electronic file is broken into discrete units that are transmitted in a series of smaller, individual parts. Further, the term includes electronic motion images maintained as a single electronic file that is transmitted as a single, complete unit to the mobile device.

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide a short expressive message. Some of these embodiments comprise a short message and a video clip including a verbalization of the short message by a character. In some of these embodiments, the verbalization is emphasized by an attribute of the character. In some of these embodiments, the attribute includes a demeanour of the character. In some of these embodiments, the attribute includes an intonation of the verbalization. In some of these embodiments, the attribute includes a volume of the verbalization. In some of these embodiments, the attribute includes a gesture. In some of these embodiments, the attribute includes a facial expression. In some of these embodiments, the video clip comprises a head shot of the character. A head shot is known in the television and movie arts as a video or still image of the head and shoulders of a subject. In some of these embodiments, the head shot is captured from a non-perpendicular angle relative to the character. In some of these embodiments, the head shot is captured from a position locate above the head of the character.

Certain embodiments of the invention provide methods for expressing a message. Some of these embodiments comprise selecting a video from a catalogue of short video, wherein the selected video conveys a message and transmitting the message to an mobile electronic device adapted to play the video clip. In some of these embodiments, the selected video conveys the message verbally. In some of these embodiments, the selected video conveys the message through a text message. In some of these embodiments, the selected video includes one or more characters. In some of these embodiments, the characters include a caricature. In some of these embodiments, the characters include a cartoon character. In some of these embodiments, the selected video includes a movie clip. In some of these embodiments, the selected video includes a television program clip. In some of these embodiments, the selected video includes an advertisement. In some of these embodiments, the selected video includes an alert. In some of these embodiments, the video is selected responsive to a request from a user of a wireless device. In some of these embodiments, the video emphasizes the message through the behavior of a character portrayed in the video.

While certain embodiments of the invention are described above, it should be understood that the invention can be embodied and configured in many different ways without departing from the spirit and scope of the invention. For example, while specialized software is not necessarily required the use of the invention in connection with various mobile devices, such specialized or proprietary software may be used in connection with the invention without compromising its effectiveness. Accordingly, some mobile device providers may include software that enhances the delivery, storage, and/or playback functionality of the particular mobile device. Also, the mobile device may be further customized for maximum connectivity transmission speed, as well as enhanced audio features for sound quality. These optional customizable aspects of the mobile device do not detract from the operation of the invention as herein described.

What is claimed is:

1. A short expressive message comprising:
a short message; and
a video clip including a verbalization of the short message by a character, wherein the verbalization is emphasized by an attribute of the character.

2. The short expressive message of claim 1, wherein the attribute includes a demeanor of the character.

3. The short expressive message of claim 1, wherein the attribute includes an intonation of the verbalization.

4. The short expressive message of claim 1, wherein the attribute includes a volume of the verbalization.

5. The short expressive message of claim 1, wherein the attribute includes a gesture.

6. The short expressive message of claim 1, wherein the attribute includes a facial expression.

7. The short expressive message of claim 1, wherein the video clip comprises a head shot of the character.

8. The short expressive message of claim 1, wherein the head shot is captured from a non-perpendicular angle relative to the character.

9. The short expressive message of claim 8, wherein the head shot is captured from a position locate above the head of the character.

10. A method for expressing a message comprising:
selecting a video from a catalogue of short video, wherein the selected video conveys a message; and
transmitting the message to an mobile electronic device adapted to play the video clip, wherein the selected video conveys the message verbally.

11. The method of claim 10, wherein the selected video conveys the message through a text message.

12. The method of claim 10, wherein the selected video includes one or more characters.

13. The method of claim 10, wherein the one or more characters include a caricature.

14. The method of claim 10, wherein the one or more characters include a cartoon character.

15. The method of claim 10, wherein the selected video includes a movie clip.

16. The method of claim 10, wherein the selected video includes a television program clip.

17. The method of claim 10, wherein the selected video includes an advertisement.

18. The method of claim 10, wherein the selected video includes an alert.

19. The method of claim 10, wherein the video is selected responsive to a request from a user of a wireless device.

20. The method of claim 10, wherein the video emphasizes the message through the behavior of a character portrayed in the video.
